(19) United States
(12) Patent Application Publication
(10) Pub. No.: US 2005/0208457 A1
(43) Pub. Date: Sep. 22, 2005

(54) Digital object recognition audio-assistant for the visually impaired

(76) Inventors: Wolfgang Fink, Montrose, CA (US); Mark Humayun, Glendate, CA (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/030,678

(22) Filed: Jan. 5, 2005

Related U.S. Application Data
(60) Provisional application No. 60/534,593, filed on Jan. 5, 2004.

(51) Int. Cl. G09B 21/00

(52) U.S. Cl. 434/112; 434/116

(57) ABSTRACT

A camera-based object detection system for a severely visually impaired or blind person consisting a digital camera mounted on the person's eyeglass or head that takes images on demand. Near-real time image processing algorithms decipher certain attributes of the captured image by processing it for edge pattern detection within a central region of the image. The results are classified by artificial neural networks trained on a list of known objects, in a look up table, or by a threshold. Once the pattern is classified a descriptive sentence is constructed of the object and its certain attributes and a computer-based voice synthesizer is used to verbally announce the descriptive sentence. The invention is used to determine the size of an object, or its distance from another object, and can be used in conjunction with an IR-sensitive camera to provide “sight” in poor visibility conditions, or at night.

### CROSS-REFERENCE TO RELATED APPLICATION(S)

The present application claims the benefit of priority from pending U.S. Provisional Patent Application No. 60/534,593, entitled “Digital Object Recognition Audio-Assistant For The Visually Impaired”, filed on Jan. 5, 2004, which is herein incorporated by reference in its entirety.

### BACKGROUND OF THE INVENTION

1. Field of the Invention

The present invention relates to the field of object recognition.

Portions of the disclosure of this patent document may contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Presently, a visually impaired person has limited choices when it comes to moving about in known or unknown territory or travel. The person has to either employ the services of another person who can see, or use the help of a seeing-eye or guide dog if the person is unfamiliar with the surroundings. Even when the person does not use the aid of another person who can see or a seeing eye dog because the environment is known to the sight impaired person (like in the person's home or work), the person may face difficulties when environmental conditions change, such as when items are misplaced, dropped, replaced in the incorrect location, etc.

In particular, a visually impaired person often wants to be able to identify certain objects without the aid of another. Even when a guide dog is available, the guide dog may not be able to identify certain objects, such as denominations of money, pens, labels on food cans, etc.

One prior art solution to aid in the identification of objects is to maintain specific locations for various items. For example, a visually impaired person may always keep the different denominations of currency in certain pockets or pouches so that an assumption can be made as to what the currency is when spending it. Also, food and drinks may be stored in specific locations based on contents, or marked with some sort of identifying marker, such as a braile tag or some other indicator that can be felt by the visually impaired person. Although these systems can work at times, they are prone to error and mistake. It is preferred to have a manner of identifying objects for a visually impaired person that does not require the aid of another person.

### SUMMARY OF THE INVENTION

The present invention provides a camera-based object detection system for a severely visually impaired or blind person. According to one embodiment of the present invention, a digital camera mounted on the person's eyeglass or head takes images on demand. Image processing algorithms are used to decipher certain attributes of the captured image frame. The content of the image frame is deciphered by processing the frame for edge pattern detection. The processed edge pattern is classified by artificial neural networks that have been trained on a list of known objects, in a look up table, or by a threshold. Once the pattern is classified a descriptive sentence is constructed consisting of the object and its certain attributes. A computer-based voice synthesizer is used to verbally announce the descriptive sentence and so identify the object audibly for the person.

According to another embodiment, the present invention is used to determine the size of an object, or its distance from another object. According to another embodiment, the present invention can be used in conjunction with an IR-sensitive camera to provide “sight” in poor visibility conditions such as dense fog, or at night.

### BRIEF DESCRIPTION OF THE DRAWINGS

FIG. 1 is a flowchart illustrating the overview of the present invention.

FIG. 2 illustrates a graphical view of the different steps of cataloging an object, according to one embodiment of the present invention.

FIG. 3 illustrates a graphical view of the different steps of detecting an object, according to one embodiment of the present invention.

### DETAILED DESCRIPTION OF THE INVENTION

A camera-based object detection system for the severely visually impaired or blind person is described. In the following description, numerous details are set forth in order to provide a more thorough description of the present invention. It will be apparent, however, to one skilled in the art, that the present invention may be practiced without these specific details. In other instances, well known features have not been described in detail so as not to unnecessarily obscure the present invention.

Overview

A camera, such as a digital camera, is mounted on the person's eyeglass or head. According to one embodiment, the view of the camera is preferably aligned with the view the person would get if he/she were not blind or visually impaired. According to another embodiment, the camera takes snap shots on demand, for example, at the push of a button by the user or a voice command. After the image is captured, it is provided to a processor for analysis. The processor uses image processing algorithms to identify one or more discernable objects in the image frame and attempts to identify them. For example, the image processing may use edge detection techniques to identify one or more objects in the captured image. For each detected object, identification algorithms are used to determine the likely identity of the object.

Any number of techniques might be used for such a task. For example, the object might be normalized and compared to a database of possible objects using geometric and/or size analysis. Consider a dollar bill in the image frame. If it is viewed askew or at an angle, a normalization routine might rotate it and compensate for skew to result in a rectangular object. The features of the image object can then be compared to the database of known rectangular objects having similar dimensional relationships, (e.g ratio of length to width, such as other currency) and the denomination can be determined. Other techniques, such as morphological filters, look-up table, trained artificial neural network, some threshold, or an object repository of learned objects may be used as well. Once the identity of the object is determined, a text to speech synthesizer is used to generate an audio output that speaks the identity of the object. For example, the system may announce to the user “You are looking at a one dollar bill”.

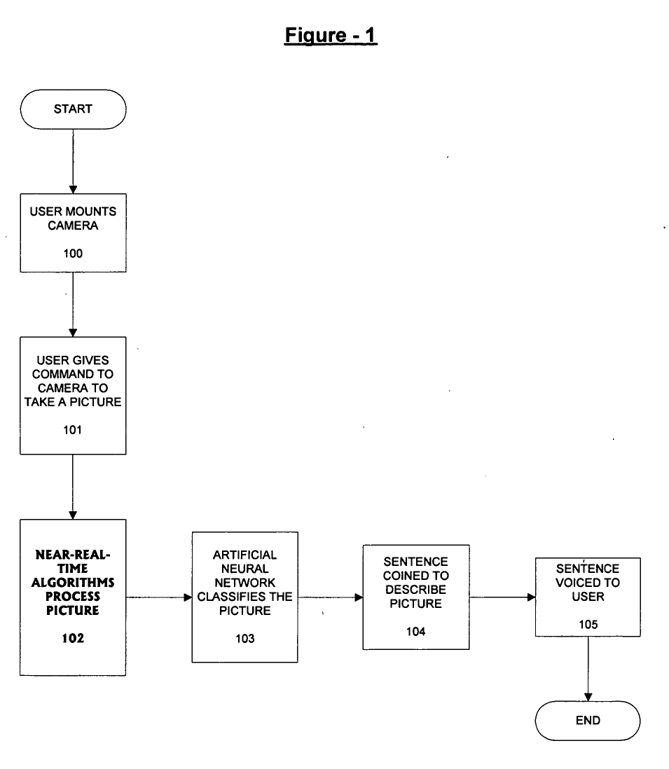

FIG. 1 is a flowchart that illustrates an overview of the present invention. At step 100 a visually impaired or blind user mounts the camera on his/her eyeglass or forehead. Next, at step 101, the user activates the system to capture an image by, for example, pushing a button or speaking a voice command to the camera to take a snap shot of the objects in its view. It should be noted here that the view of the camera can be different or the same as the view that the user would get if he/she could see. Next, at step 102, near-real-time image processing algorithms act on the captured image to identify individual objects within the snap shot image. Next, at step 103, an artificial neural network or other technique is used to classifies the objects within the snap shot. Next, at step 104, a sentence is coined to describe the objects within the snap shot to the user. Next, at step 105, the sentence is voiced to the user via a speaker or earphone.

We will now discuss the individual aspects and components of the present invention in more detail.

Camera

As mentioned above the camera is preferably a digital camera that is small enough that it can be easily mounted on the eyeglass of the user, forehead of a user, or at some inconspicuous location. According to one embodiment, the camera is wired or wireless depending on its use, and is a stand alone unit or coupled to a microphone device (see further below). Also depending on the motive of using the present invention, the view of the camera can be fixed or variable. For example, if the user (who we have mentioned earlier is a visually impaired or blind person) is using the camera attached to him/herself to view the objects in his/her path, then the angle of the camera is preferably positioned in the same direction as what the user would see if he/she could see. On the other hand, if the camera is used for security, reconnaissance, or to provide “sight” in poor visibility conditions such as fog or at night, then the view of the camera can be either fixed to a particular angle, or can be changed at a fixed or variable interval using a looped algorithm. For example, if the camera is used for surveillance purposes, then an algorithm that moves the view of the camera back and forth in an arc pattern at a fixed or variable interval can be used.

According to another embodiment, the camera is programmed to take a snap shot of an image in its view mechanically, or at some predetermined instance, or can be used in a “search” mode. The mechanical methods include the user pressing a button similar to taking on picture on a conventional camera, or using a microphone device attached close to the user's mouth and connected wirelessly or with wires to the camera to give a vocal command to the camera. The camera can also be programmed or initiated to take images at a predetermined instance or some variable moment. In a “search” mode, the camera can be used to determine if a certain object is in view. For example, a user could use the camera in a known setting (his/her house) and ask the camera if a particular item, say a toothbrush is within its view. If the item is, then the system relays back to the user its position using a coordinate system.

Once the camera has taken a snap shot, near-real-time image processing algorithms then processes certain attributes of the image and of the objects within the image.

Attributes

According to another embodiment, some of the attributes of the image and the objects within the image processed include, but are not limited to, the brightness and color of each object, and the contents of the entire image. The brightness of the object includes, but is not limited to, the object categorized as being bright, medium, or dark. These parameters of bright, medium, or dark are set using a range of color coordination, or visual perception in which a source appears to emit a given amount of light. The range can also be set differently for objects that are opaque, translucent, or transparent in nature.

The color of the object may include a predefined color palatte. For example, additive color scheme (RGB color scheme), subtractive color scheme (RYB color scheme), CMYK color sheme, or gray scale color scheme.

The contents of the image are determined by first processing for edge detection within a central region of the image to avoid disturbing effects along the border. According to another embodiment, the edge detection is performed using image segmentation schemes, or clustering techniques. According to another embodiment, the present invention is capable of removing “noise”, which are values smaller than a predetermined threshold, to clean up the image for cataloging and identifying. According to another embodiment, the resulting edge pattern of each object within the image is then classified by an artificial neural network that has been trained on a list of known objects, in a look up table for quick future reference, or by a predetermined threshold.

Feedback to User

Once the pattern is classified a descriptive sentence is constructed in the users language describing the object and its attributes. According to another embodiment, instead of constructing a descriptive sentence, the present invention constructs key words describing the object. For example, if the camera is used to detect objects in front of a user and a chair is detected as an object within the image, the descriptive sentence could be: “A blue chair present to your left”. On the other hand, if the camera is used in the “search” mode and the user wants to know if there is a blue chair in view and one is present, the descriptive sentence could be: “A blue chair is present about 3 feet to your right”. The descriptive sentence or key words are verbally announced to the user using a computer-based voice or text-to-speech synthesizer. According to one embodiment, the synthesizer is wired to the camera, or wirelessly connected to the camera.

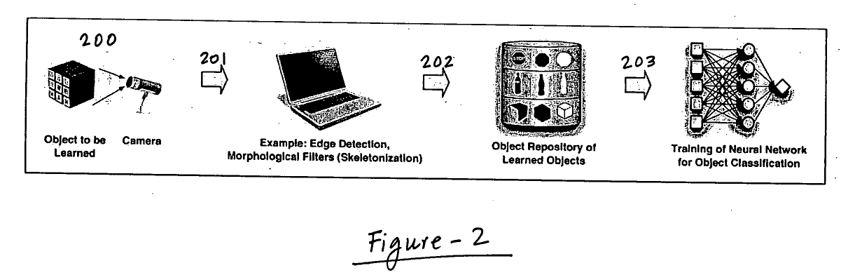

FIG. 2 illustrates a graphical view of the different steps of cataloging an object, according to one embodiment of the present invention. At step 200, a camera takes a snap shot of an object. It should be noted here that the camera can take multiple snap shots from different angles and distances to capture minute details of the object in order to catalogue it properly. Next, at step 201, the image is sent to a system that uses edge detection or morphological filters to process the image. Next, at step 202 the features of the image are fed to a repository of learnt objects. Finally, at step 203, a neural network accesses the repository to identify the object.

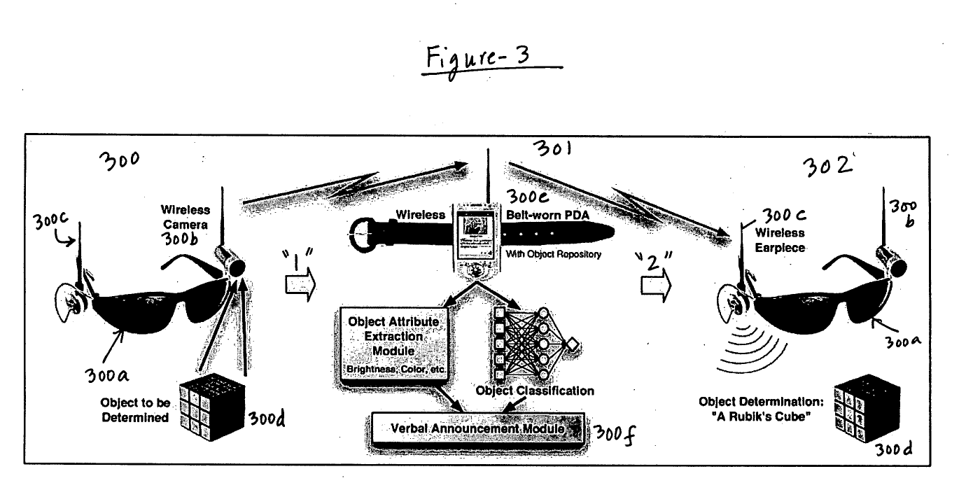

FIG. 3 illustrates a graphical view of the different steps of detecting an object, according to one embodiment of the present invention. The figure should be viewed from left to right, and consists of 3 main clusters separated by arrows. Cluster 300 consists of a pair of glasses 300a on which is mounted a wireless camera 300b and a wireless (or wired) ear/mouth piece 300c, and the object 300d to be detected. In operation, the camera is positioned so that is captures the complete view of the object. Once the image of the object is captured, we move to cluster 301. The analysis of the object using near-real time image processing algorithms is conveyed to cluster 301 via arrow marked “1”. It should be noted again that the analysis could be conveyed wirelessly or through a wired connection from cluster 300 to cluster 301. Cluster 301 contains a wireless PDA 300e attached to a watch strap that uses the analysis of the object through a neural network or using the attributes of the object to coin a sentence within verbal announcement module 300f. Once the verbal announcement is coined, we move to cluster 302. The verbal announcement is conveyed to cluster 302 via arrow marked “2”. It should be noted again that the announcement could be conveyed wirelessly or through a wired connection from cluster 301 to cluster 302. Cluster 302 contains the same pair of glasses and object as cluster 300. In operation, the verbal announcement is played to the user via the wireless (or wired) ear/mouth piece 300c (illustrated as a set of concentric arcs).

Training

In one embodiment, the user is assisted through an initial setup phase of the system so that the system can be trained to recognize objects useful to the individual user. In this training phase, the objects desired to be recognized by the user are imaged by the camera, recognized as objects, and given standard names or names that are customized for each user. This may be in place of, or in addition to, a standard library of common objects preprogrammed into a standard library of recognizable objects. In addition, the system may be switched by the user into a training mode at any time, if it is desired to add new objects to the system.

In another embodiment, the system may store the user's own voice stating the name of identified objects instead of using a synthesized voice.

Other Usage

Since the camera can work as the “eyes”, and the near-real time image processing algorithms detect virtually any object based on its color, brightness, and shape, the present invention can be used in surveillance, as a security device, or for reconnaissance missions without endangering the lives of humans. The camera can work with infrared light and under night or foggy weather conditions. The camera can have laser oscillation to determine the distance of an object from the user or from another object. The camera can be equipped with a motion detector that could give positional beeping when an object moves into its field of vision. The detection could be accomplished using rotational sonar, radar, or laser.

Thus, a camera-based object detection system for the severely visually impaired or blind person is described in conjunction with one or more specific embodiments. The invention is defined by the following claims and their full scope of equivalents.

1. An object detection system, comprising:
a digital camera mounted on a user to take an image on demand;
one or more near-real time image processing algorithms connected to said camera to decipher attributes of said image;
an announcement module connected to said algorithms to construct a sentence to describe said image; and
a computer-based voice synthesizer connected to said module to verbally announce said sentence to said user.

2. The system of claim 1 wherein said camera is mounted on said user's eyeglass.

3. The system of claim 1 wherein said camera is mounted on said user's forehead.

4. The system of claim 1 wherein said algorithms decipher said attributes by processing said image for edge pattern detection.

5. The system of claim 4 wherein processing of said image is classified in a look up table.

6. The system of claim 4 wherein processing of said image is classified by a threshold.

7. The system of claim 4 wherein processing of said image is classified by an artificial neural network.

8. The system of claim 7 wherein said network has a list of known objects within its memory.

9. The system of claim 1 wherein said attributes are color, brightness, or content of said image.

10. An object detection system capable of determining an object's size.

11. An object detection system capable of determining an object's distance from another.

12. An object detection system combinable with an IR-sensitive camera for image processing under difficult light conditions.
